(19) United States
(12) Patent Application Publication
(10) Pub. No.: US 2014/0124223 A1
(43) Pub. Date: May 8, 2014

(54) METHOD FOR MIXING FIRE FIGHTING GEL IN SITU WITHIN A WATER TANK OF A FIRE FIGHTING AIRCRAFT, AND A FIRE FIGHTING AIRCRAFT MODIFIED IN ACCORDANCE WITH THE TEACHINGS OF THE METHOD

(71) Applicant: Rick Solomon, Onoway (CA)

(72) Inventor: Rick Solomon, Onoway (CA)

(21) Appl. No.: 14/050,095

(22) Filed: Oct. 9, 2013

(30) Foreign Application Priority Data
Nov. 2, 2012 (CA) 2795118
Jun. 11, 2013 (CA) 2818419

(51) Int. Cl. A62C 5/00; A62C 5/033; A62C 3/02

(52) U.S. Cl. CPC A62C 5/002; A62C 3/0228; A62C 5/033
USPC 169/44; 169/53

(57) ABSTRACT

A method for mixing fire fighting gel in situ within a water tank of a fire fighting aircraft. A first step involves mounting a chemical tank to a fire fighting aircraft having a water tank. A second step involves injecting gel forming chemical from the chemical tank into a turbulent flow of water entering the water tank of the aircraft to achieve a required ratio of gel forming chemical and water, with the turbulent flow of water serving to mix the gel forming chemical with the water.

### FIELD

There is described a method for mixing fire fighting gel in situ within a water tank of a fire fighting aircraft and a fire fighting aircraft that has been modified in accordance with the teachings of the method.

### BACKGROUND

Specialized aircraft, both airplanes and helicopters, have been developed for use in fighting fires. Each airplane has a large water tank and is equipped with a water scoop which skims water from a surface of a lake, river or other body of water to fill the water tank. Each helicopter has a snorkle that can be dropped into a body of water and a pump to draw water up the snorkle into the water tank. These innovations enable the airplanes and helicopters to refill their water tanks without having to return to an airport.

It has been determined that the use of a fire fighting gel is more effective in fighting fires than the use of water alone. At the present time, airplanes and helicopters must return to a gel mixing site to get their tanks refilled with fire fighting gel. With helicopters, the gel mixing site can be a large clearing. With airplanes, the gel mixing site must be at an airport. Valuable time is being lost in travelling to and from distant airports. Merely adding chemical to water in the water tank of a fire fighting airplane or helicopter is not an option, as mixing is required for chemical and water to form fire fighting gel. What is required is a manner of adding and mixing chemical in the tank of a fire fighting airplane or helicopter to form fire fighting gel.

### SUMMARY

According to one aspect, there is provided a method for mixing fire fighting gel in situ within a water tank of a fire fighting aircraft. A first step involves mounting a chemical tank to a fire fighting aircraft having a water tank. A second step involves injecting gel forming chemical from the chemical tank into a turbulent flow of water entering the water tank of the aircraft to achieve a required ratio of gel forming chemical and water, with the turbulent flow of water serving to mix the gel forming chemical with the water.

The reason the above described method works is the turbulence caused during filling. With an aircraft, the water scoop fills the water tank in between five to twelve seconds. With a helicopter, water is pumped up the snorkle to fill the water tank at rates which vary between five seconds and one and one half minutes. It will be appreciated that the more rapid the filling action, the greater the associated turbulence, which can be used to mix gel forming chemicals with water to form fire fighting gel.

According to another aspect, there is provided a combination of components for use in practising the method. The combination includes a fire fighting aircraft having a water tank, a chemical tank mounted to the aircraft and a chemical injection assembly for injecting chemical from the chemical tank into a conduit through which water passes when filling the water tank from a body of water. When the fire fighting aircraft is an airplane, water to fill the water tank is fed into the conduit from a water scoop which skims water from a surface of a body of water. When the fire fighting aircraft is a helicopter, the conduit is a snorkle tube with associated pump water that draws water from a body of water up the snorkle tube into the water tank.

Once the critical issue of mixing was solved, a secondary problem that had to be addressed was how to inject sufficient chemical to form the gel in the short time span that it took for the water scoop to fill the water tank. Beneficial results were obtained through the use of a cylinder with a double acting piston. The double acting piston divides the cylinder into a first chamber and a second chamber. A first supply connection connects the first chamber with the chemical tank. A first injection connection connects the first chamber with an injector nozzle. A second supply connection connects the second chamber with the chemical tank. A second injection connection connects the second chamber with an injector nozzle. Check valves are provided which are activated by movement of the double acting piston. Movement of the double acting piston in a first direction results in chemicals in the first chamber being forced through the first injection connection to the injector nozzle and concurrently results in chemicals being drawn from the chemical tank through the second supply connection to fill the second chamber. Movement of the double acting piston in a second direction results in chemicals in the second chamber being forced through the second injection connection to the injector nozzle and concurrently results in chemicals being drawn from the chemical tank through the first supply connection to fill the first chamber.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a schematic view of a chemical injector with no flow between the injector package and the water tank in a helicopter.

FIG. 2 is a schematic view of the chemical injector shown in FIG. 1 with flow between the injector package and the water tank.

FIG. 3 is a schematic view of the chemical injector shown in FIG. 1 with flow between the injector package and the water tank.

FIG. 4 is a side elevation view of a helicopter prior to mixing of fire fighting gel.

FIG. 5 is a side elevation view of the helicopter shown in FIG. 4 during mixing of fire fighting gel.

FIG. 6 is a schematic view of an injector with no flow between the injection assembly and the water tank in an airplane.

FIG. 7 is a schematic view of the chemical injector shown in FIG. 6 with flow between the injector package and the water tank.

FIG. 8 is a schematic view of the chemical injector shown in FIG. 6 with flow between the injector package and the water tank.

FIG. 9 is a schematic view of a chemical injector assembly with an alternative piston configuration.

FIG. 10 is a schematic view of the piston configuration shown in FIG. 6 with arrows showing liquid movement as the piston travels in a first direction.

FIG. 11 is a schematic view of the piston configuration shown in FIG. 6 with arrows showing liquid movement as the piston travels in a second direction.

FIG. 12 is a perspective view of a portion of the chemical injector assembly.

### DETAILED DESCRIPTION

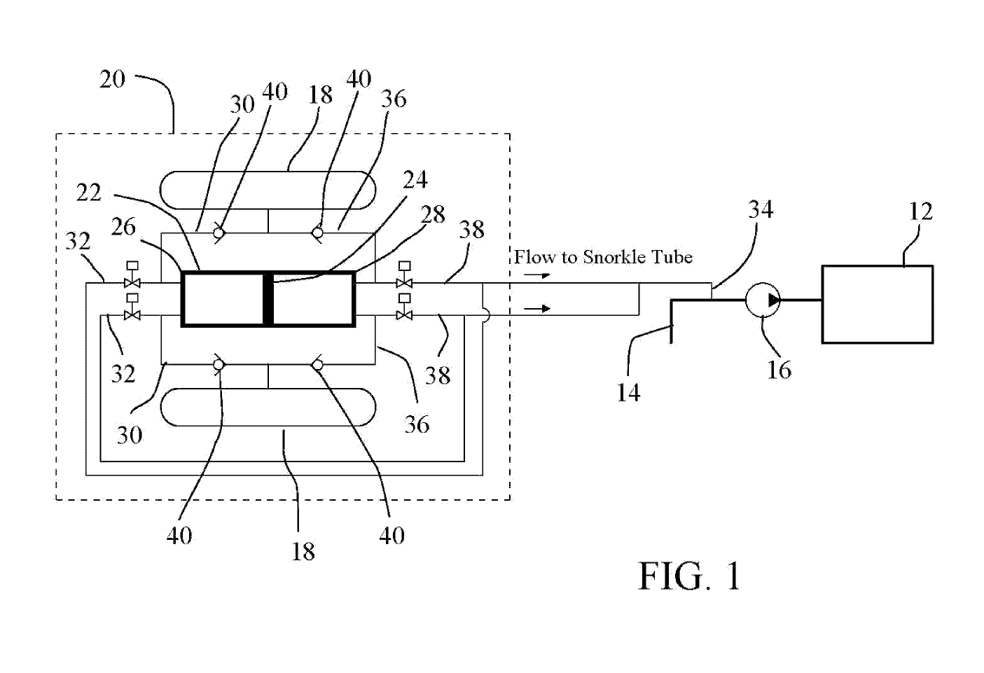

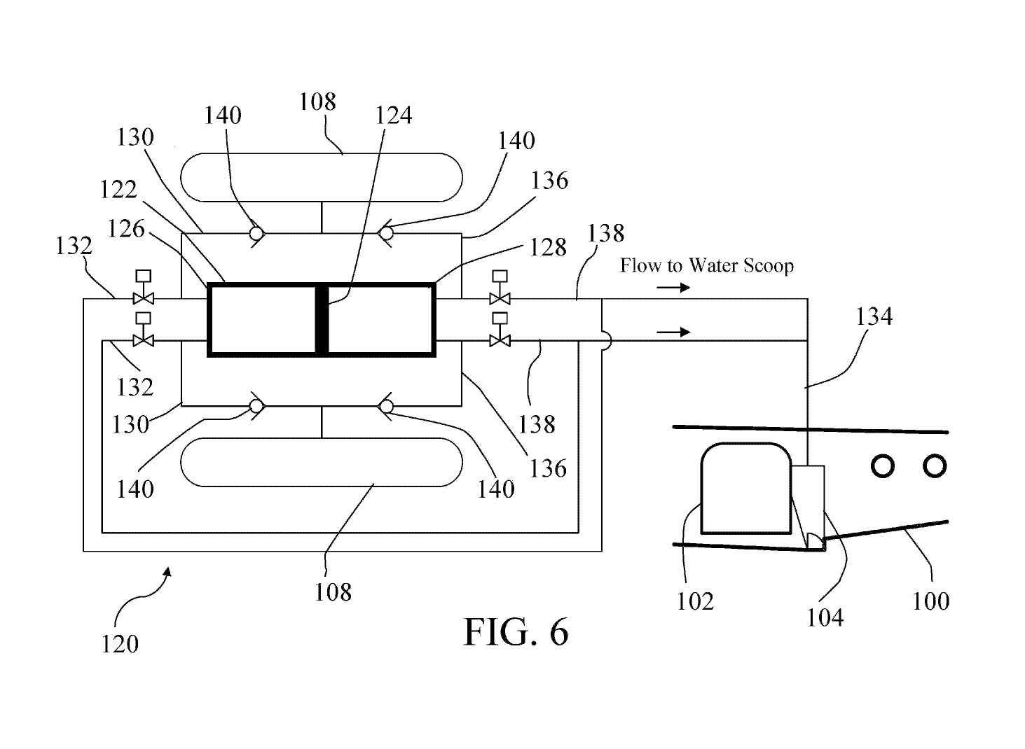

The method and fire fighting aircraft modified in accordance with the method will now be described. A fire fighting helicopter, generally identified by reference numeral 10, will be described with reference to FIG. 1 through 5. A fire fighting airplane, generally identified by reference numeral 100, will be described with reference to FIG. 6 through 8.

### Structure and Relationship of Parts:

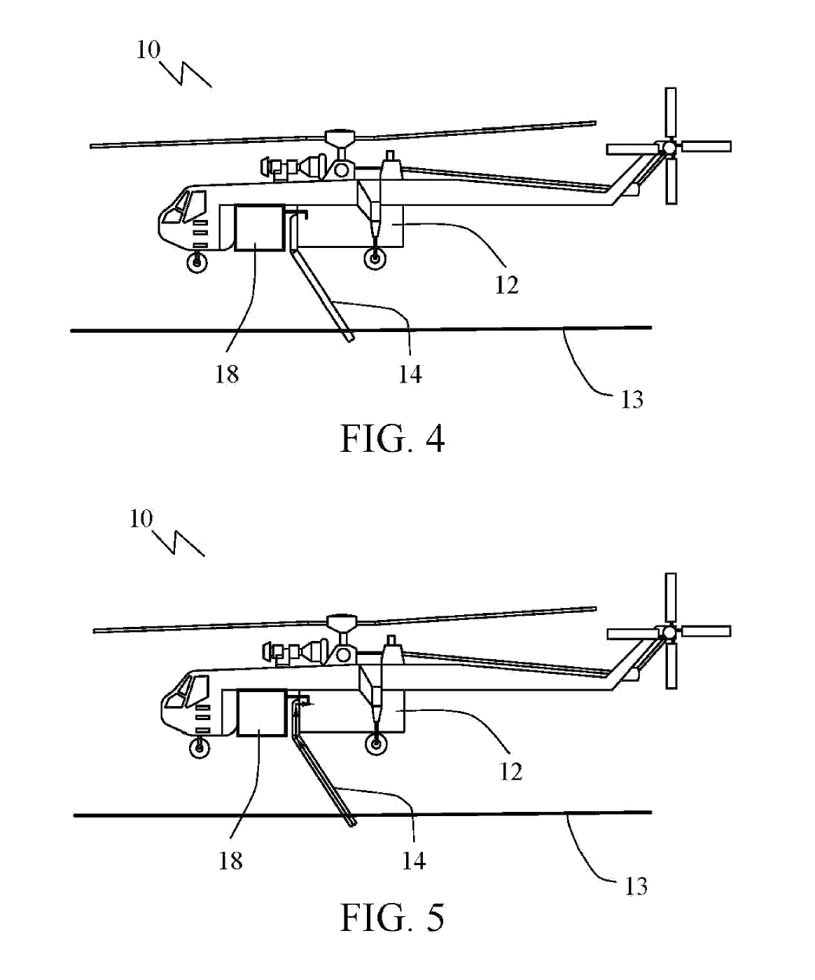

Referring to FIGS. 4 and 5, a fire fighting aircraft such as a helicopter 10 has a water tank 12 that allows for ejection of water or other fluid from the helicopter 10. Referring to FIG. 1, a conduit, such as a snorkle tube 14, with an associated pump 16 draws water from a body of water 13 up the snorkle tube 14 into the water tank 12. Referring to FIG. 4, a chemical tank 18 is mounted to the helicopter 10 with a chemical injection assembly 20 provided for injecting chemical from the chemical tank 18 into the snorkle tube 14 through which water passes when filling the water tank 12 from a body of water.

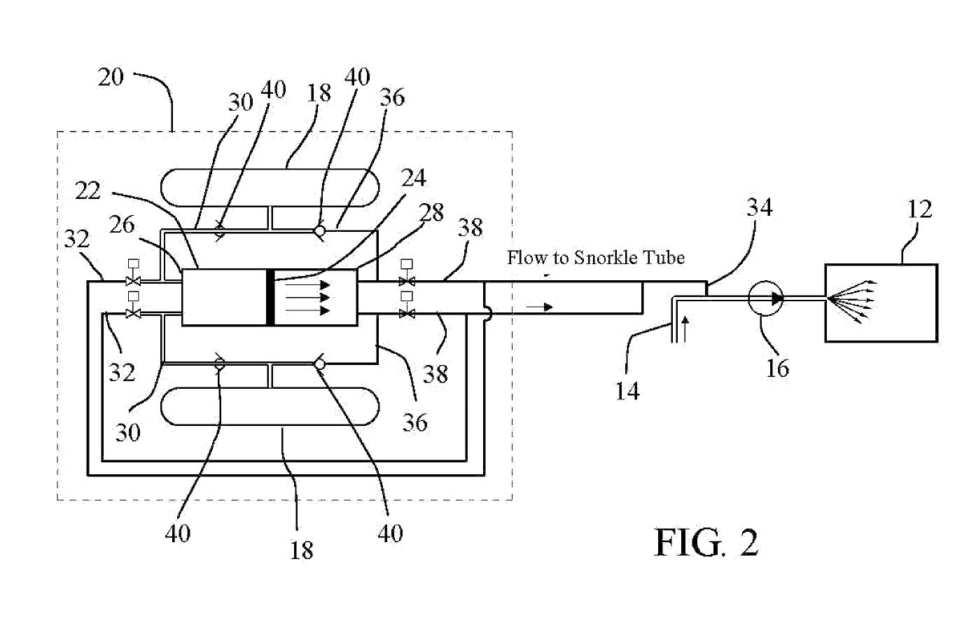

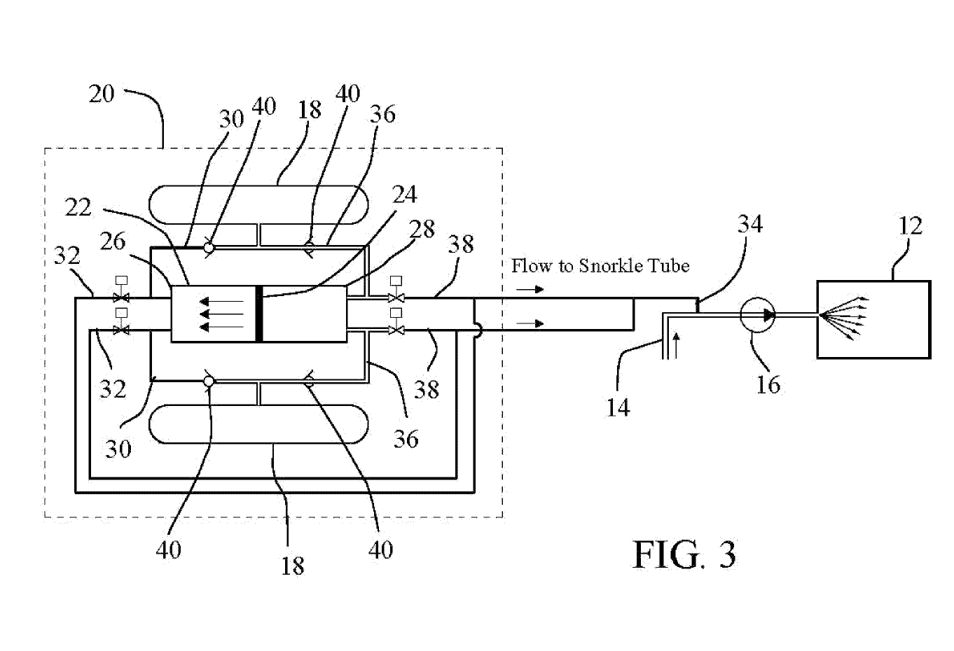

Referring to FIG. 1, the chemical injection assembly 20 includes a cylinder 22 with a double acting piston 24 that divides the cylinder 22 into a first chamber 26 and a second chamber 28. A first supply conduit 30 connects the first chamber 26 with the chemical tank 18 and a first injection conduit 32 connects the first chamber 26 with an injector nozzle 34. A second supply conduit 36 connects the second chamber 28 with the chemical tank 18. A second injection conduit 38 connects the second chamber 28 with the injector nozzle 34. Check valves 40 are activated by movement of the double acting piston 24. Referring to FIG. 3, movement of the double acting piston 24 in a first direction results in chemicals in the first chamber 26 being forced along the first injection conduit 32 to injector nozzle and concurrently results in the chemicals being drawn from the chemical tank 18 along the second supply conduit 36 to fill the second chamber 28. Referring to FIG. 2, movement of the double acting piston 24 in a second direction results in chemicals in the second chamber 28 being forced along the second injection conduit 36 to the injector nozzle 34 and concurrently results in the chemicals being drawn from the chemical tank 18 along the first supply conduit 30 to fill the first chamber 26.

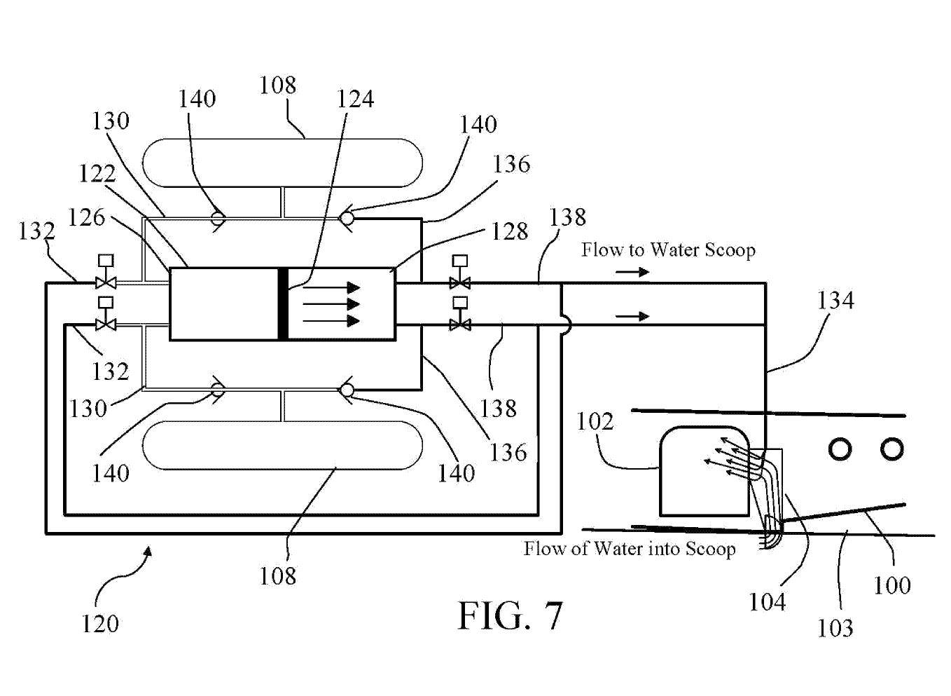

Referring to FIG. 7, a fire fighting airplane 100 may also be used. Airplane 100 has a water tank 102 that allows for ejection of water or other fluid from the airplane 100. Water to fill water tank 102 is fed into a conduit, such as a water scoop 104, by skimming water from a surface of a body of water 103. A chemical tank 108 is mounted to the airplane 100 with a chemical injection assembly 20 provided for injecting chemical from the chemical tank 108 into the water scoop 104 through which water passes when filling the water tank 102 from a body of water 103.

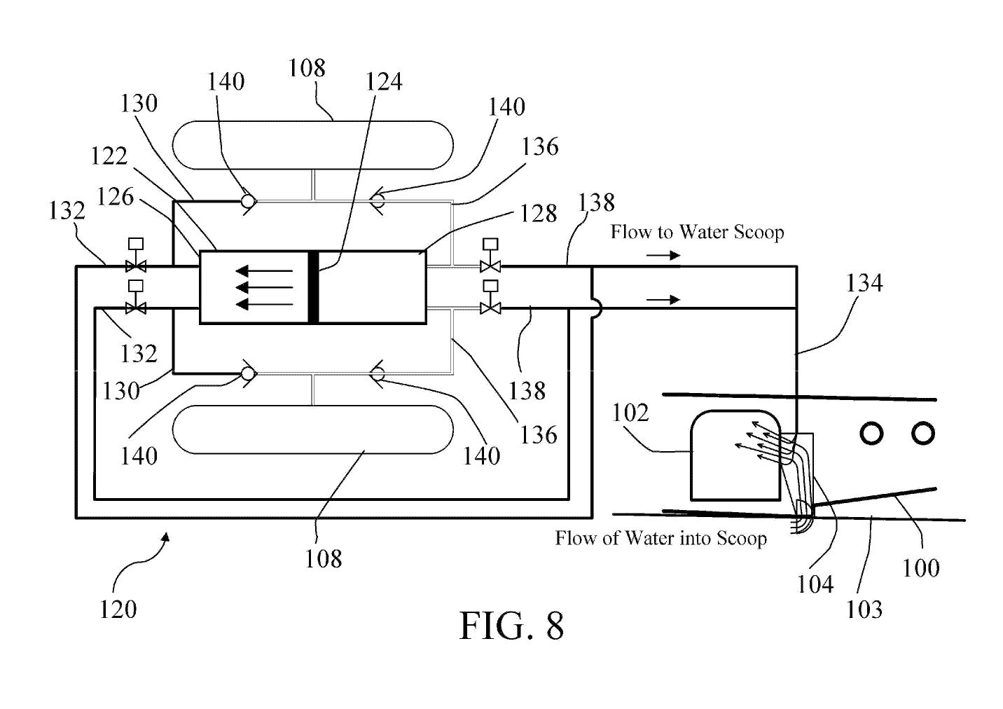

Referring to FIG. 6, the chemical injection assembly 120 includes a cylinder 122 with a double acting piston 124 that divides cylinder 122 into a first chamber 126 and a second chamber 128. A first supply conduit 130 connects the first chamber 126 with the chemical tank 108 and a first injection conduit 132 connects the first chamber 126 with an injector nozzle 134. A second supply conduit 136 connects the second chamber 128 with the chemical tank 108. A second injection conduit 138 connects the second chamber 128 with the injector nozzle 134. Check valves 140 are activated by movement of the double acting piston 124. Referring to FIG. 8, movement of the double acting piston 124 in a first direction results in chemicals in the first chamber 126 being forced along the first injection conduit 132 to the injector nozzle and concurrently results in the chemicals being drawn from the chemical tank 108 along the second supply conduit 136 to fill the second chamber 128. Referring to FIG. 7, movement of the double acting piston 124 in a second direction results in chemicals in the second chamber 128 being forced along the second injection conduit 136 to the injector nozzle 134 and concurrently results in the chemicals being drawn from the chemical tank 108 along the first supply conduit 130 to fill the first chamber 126.

### Operation:

Referring to FIG. 5, in a helicopter 10, fire fighting gel is mixed in situ within the water tank 12. Referring to FIG. 1, the chemical injection assembly 20 is in fluid communication with the water tank 12 of the helicopter 10. Referring to FIG. 5, water from a water source 13, such as a lake, passes through the snorkle tube 14 into the water tank 12 of the fire fighting helicopter 10. Referring to FIG. 1, the pump 16 helps uptake of water through the snorkle tube 14. While water is entering the water tank 12, the chemical injection system 20 injects chemicals into the snorkle tube 14 which causes a mixture of water and chemical to enter the water tank 12 which causes formation of a fire fighting gel. The injection time required to obtain an appropriate mix ratio of chemical to water varies depending on the mix ratio and the time of aircraft and conduit used. Referring to FIG. 5, for example, the use of a helicopter 10 with a snorkle tube 14 with a pump 16 creating a mix ratio of 0.5% to 3% may take from 5 seconds to upwards of 90 seconds.

Referring to FIG. 1, the chemical injection system 20 works by movement of the double acting piston 24. Check valves 40 are activated by movement of the double acting piston 24 and allow for movement of chemicals from the chemical injection system 20 to the water tank 12. Referring to FIG. 3, movement of the double acting piston 24 in a first direction results in chemicals in the first chamber 26 being forced along the first injection conduit 32 to the injector nozzle and draws chemicals from the chemical tank 18 along the second supply conduit 36 to fill the second chamber 28. Referring to FIG. 2, movement of the double acting piston 24 in a second direction results in chemicals in the second chamber 28 being forced along the second injection conduit 36 to the injector nozzle 34 and draw chemicals from the chemical tank 18 along the first supply conduit 30 to fill the first chamber 26. Referring to FIGS. 2 and 3, injection of the chemical during water uptake is preferably done just prior to pump 16 to allow the pump 16 to mix the chemical with the water; however, it will be understood that the chemical can be injected into the water at any point along the snorkle tube 14.

Referring to FIG. 6, in an airplane 100, fire fighting gel is mixed in situ within the water tank 102. A chemical injection assembly 120 is in fluid communication with the water tank 102 of the airplane 100. Water from a water source 103, such as a lake, passes through the water scoop 104 into the water tank 102 of fire fighting aircraft. While water is entering the water tank 102, the chemical injection system 120 injects chemicals into the water scoop 104 which causes a mixture of water and chemical to enter the water tank 102 which causes formation of a fire fighting gel. The injection time required to obtain an appropriate mix ratio of chemical to water varies depending on the mix ratio and conduit used. For example, the use of an airplane 100 using a water scoop 104 creating a mix ratio of 0.5% to 3% may take from 5-12 seconds.

Referring to FIG. 6, the chemical injection system 120 works by movement of the double acting piston 124. Check valves 140 are activated by movement of the double acting piston 124 and allow for movement of chemicals from the chemical injection system 120 to the water tank 102. Referring to FIG. 8, movement of the double acting piston 124 in a first direction results in chemicals in the first chamber 126 being forced along the first injection conduit 132 to the injector nozzle and draws chemicals from the chemical tank 108 along the second supply conduit 136 to fill the second chamber 128. Referring to FIG. 7, movement of the double acting piston 124 in a second direction results in chemicals in the second chamber 128 being forced along the second injection conduit 136 to the injector nozzle 134 and chemicals from the chemical tank 108 being drawn along the first supply conduit 130 to fill the first chamber 126.

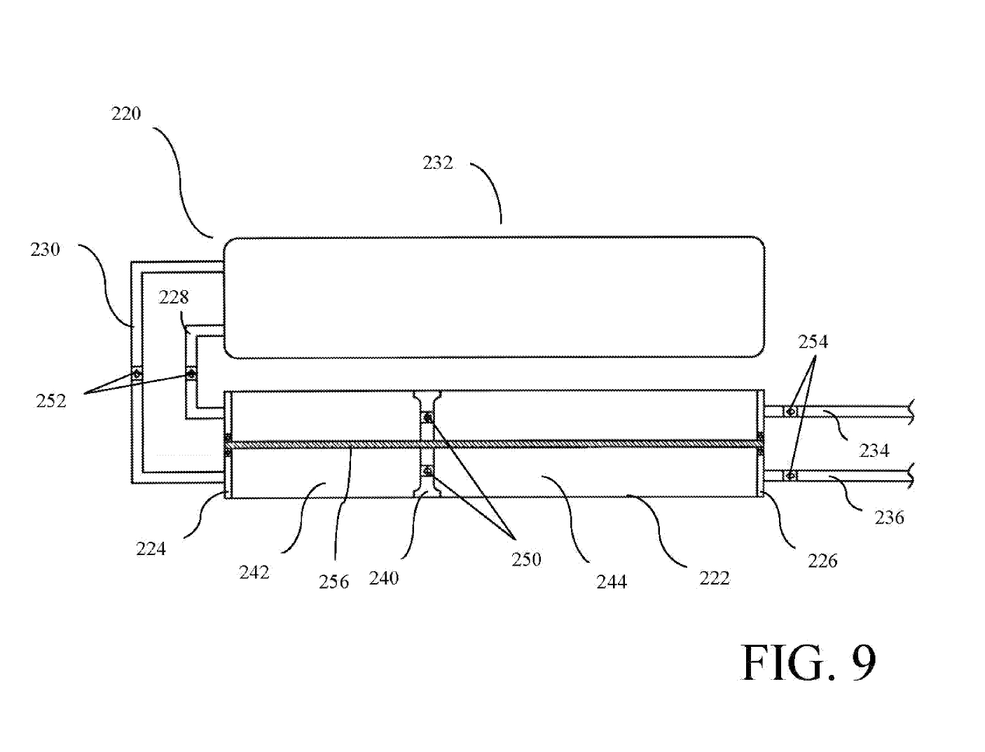

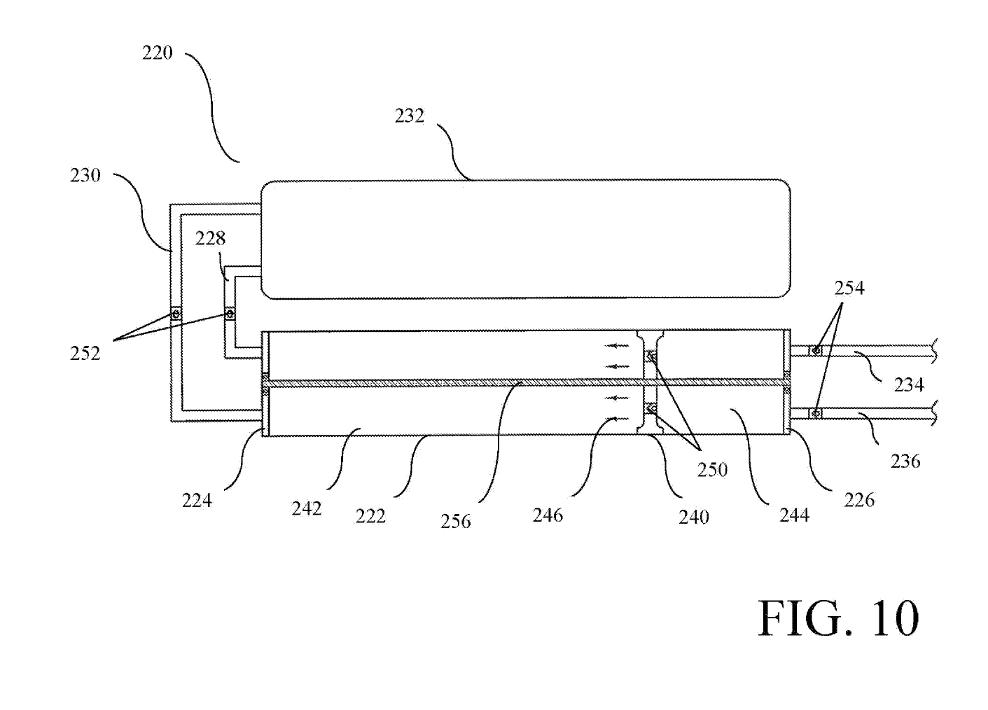

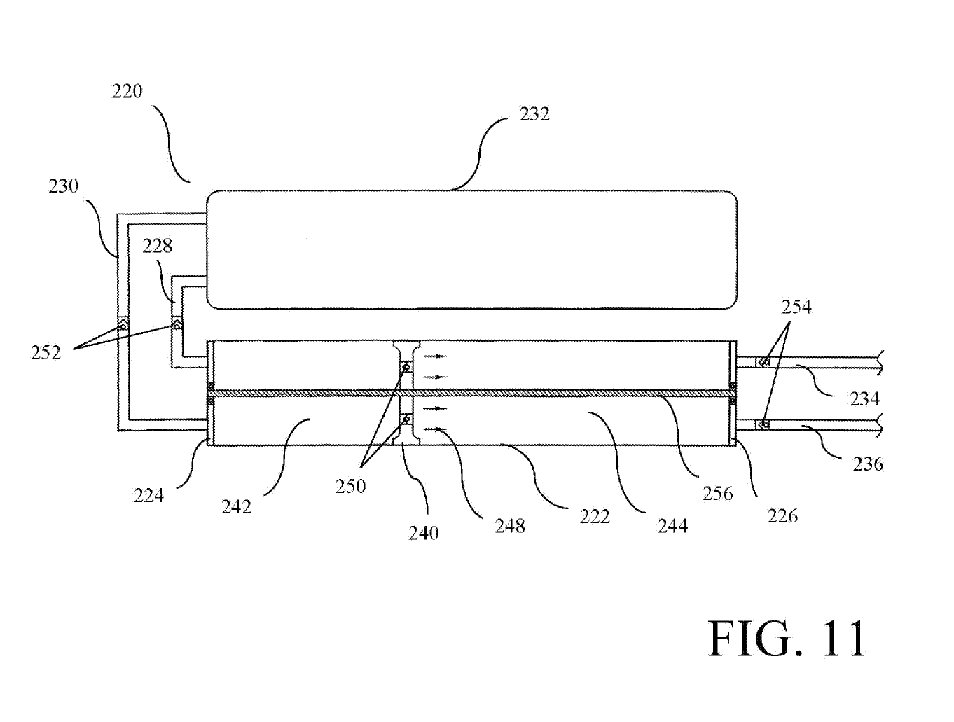

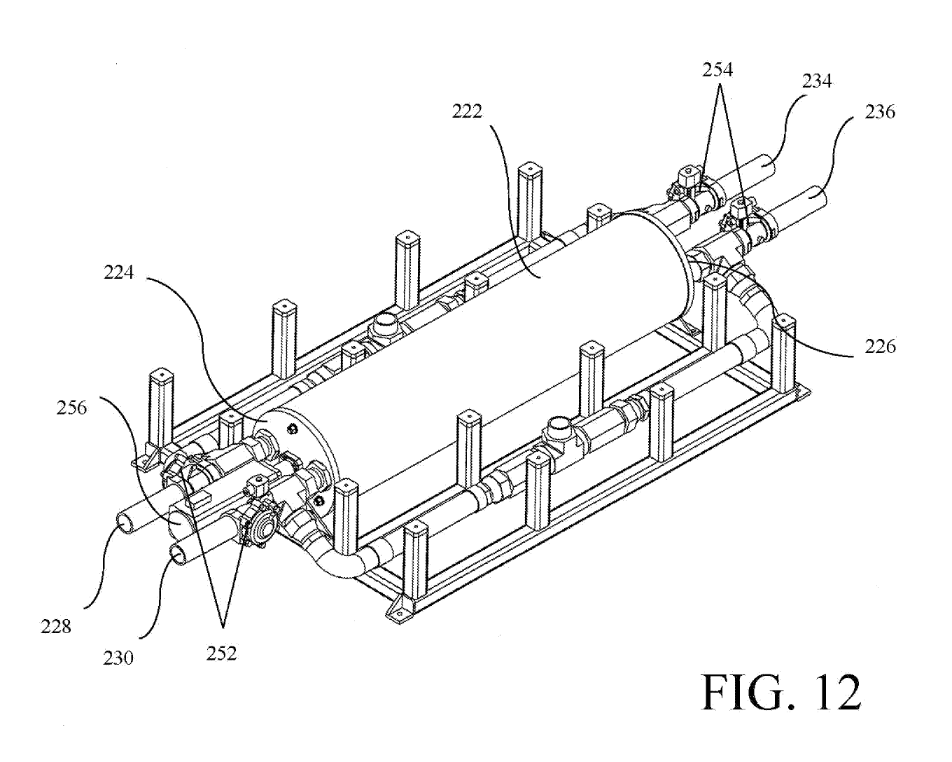

Referring to FIGS. 9 through 12, there is illustrated an alternative chemical injection assembly 220 that uses an alternative piston configuration. This alternative chemical injection assembly 220 was developed with three objectives in mind. The first objective was to reduce the amount of weight. The second objective was to reduce the complexity of the piping and valving. The third objective was to make installation and maintenance easier. For operation in alternative chemical injection assembly 220, the chemicals from which foam is produced were intentionally made more concentrated and less viscose having a mix ratio of 0.1% to 3%. The alternative chemical injection assembly 220 includes a cylinder 222 having a first end 224 and a second end 226. A working example of a cylinder 222 is shown in FIG. 12. Referring again to FIGS. 9 through 12, a pair of supply connection lines 228 and 230 at the first end 224 connects the cylinder 222 with a chemical tank 232. A pair of injection connection lines 234 and 236 at the second end 226 connects the cylinder 222 with an injector nozzle (not shown in this view). A piston 240 divides the cylinder 222 into a first chamber 242 and a second chamber 244. The relative size of the first chamber 242 and the second chamber 244 is altered as the piston 240 moves in a first direction toward the first end 224 (as shown by arrows 246 in FIG. 11) or a second direction toward the second end 226 (as shown by arrows 248 in FIG. 10). Referring to FIG. 10, as the piston 240 moves in the first direction 246, the first chamber 242 contracts and the second chamber 244 expands. Referring to FIG. 10, as the piston 240 moves in the second direction 248, the first chamber 242 expands and the second chamber 244 contracts. Referring to FIG. 10, a pair of unidirectional check valves 250 is positioned in the piston 240 that is open to permit flow through the piston 240 as the piston 240 moves in the first direction 246. Referring to FIG. 11, check valves 250 close to block flow through piston 240 as piston 240 moves in second direction 248. A pair of unidirectional check valves 252 are positioned in supply connection lines 228 and 230. Referring to FIG. 10, check valves 252 are closed to block flow through supply connection lines 228 and 230 when piston 240 moves in first direction 246. Referring to FIG. 11, checks valves 252 are open to permit flow through supply connection lines 228 and 230 into cylinder 222 when piston 240 moves in second direction 248. Referring to FIG. 10, a pair of unidirectional check valves 254 are positioned in the injection connection lines 234 and 236 that close to block flow through the injection connection lines 234 and 236 when the piston 240 moves in the first direction 246. Referring to FIG. 11, the check valves 254 open to permit flow through the injection connection lines 234 and 236 when the piston moves 240 in the second direction 248. It will be appreciated that the opening and closing of the above-described check valves is activated by movement of the piston 240. The piston 240 is moved by a rotating screw 256. Referring to FIG. 10, gel forming chemical is transferred from the first chamber 242 to the second chamber 244 as the piston 240 moves in the first direction 246. Referring to FIG. 11, the gel forming chemical is drawn along the supply connection lines 228 and 230 from the chemical tank 232 into the first chamber 242 and from the second chamber 244 into the injection connection lines 234 and 236 as the piston 240 moves in the second direction 248. As previously described with respect to the chemical injection assembly 120, while water is entering the water tank 102, the alternative chemical injection system 220 injects chemicals into the water. The chemicals mix with the water forming a fire fighting gel.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

The following claims are to be understood to include what is specifically illustrated and described above, what is conceptually equivalent, and what can be obviously substituted. Those skilled in the art will appreciate that various adaptations and modifications of the described embodiments can be configured without departing from the scope of the claims. The illustrated embodiments have been set forth only as examples and should not be taken as limiting the invention. It is to be understood that, within the scope of the following claims, the invention may be practiced other than as specifically illustrated and described.

What is claimed is:

1. A method for mixing fire fighting gel in situ within a water tank of a fire fighting aircraft, comprising:
mounting a chemical tank to a fire fighting aircraft having a water tank; and
injecting gel forming chemical from the chemical tank into a turbulent flow of water entering the water tank of the aircraft to achieve a required ratio of gel forming chemical and water, with the turbulent flow of water serving to mix the gel forming chemical with the water.

2. In combination:
a fire fighting aircraft having a water tank;
a chemical tank mounted to the aircraft; and
a chemical injection assembly for injecting chemical from the chemical tank into a conduit through which water passes when filling the water tank from a body of water.

3. The combination of claim 2, wherein the fire fighting aircraft is an airplane and water to fill the water tank is fed into the conduit from a water scoop which skims water from a surface of a body of water.

4. The combination of claim 2, wherein the fire fighting aircraft is a helicopter and the conduit is a snorkle tube with associated pump that draws water from a body of water up the snorkle tube into the water tank.

5. The combination of claim 2, wherein the chemical injection assembly comprises:
a cylinder;
a double acting piston that divides the cylinder into a first chamber and a second chamber;
a first supply connection connecting the first chamber with the chemical tank;
a first injection connection connecting the first chamber with an injector nozzle;
a second supply connection connecting the second chamber with the chemical tank;
a second injection connection connecting the second chamber with an injector nozzle; and
check valves activated by movement of the double acting piston, wherein movement of the double acting piston in a first direction results in chemicals in the first chamber being forced through the first injection connection to the injector nozzle and concurrently results in chemicals being drawn from the chemical tank through the second supply connection to fill the second chamber, and movement of the double acting piston in a second direction results in chemicals in the second chamber being forced through the second injection connection to the injector nozzle and concurrently results in chemicals being drawn from the chemical tank through the first supply connection to fill the first chamber.

6. The combination of claim 2, wherein the chemical injection assembly comprises:
a cylinder having a first end and a second end;
a supply connection at the first end connecting the cylinder with the chemical tank;
an injection connection at the second end connecting the cylinder with an injector nozzle;
a piston dividing the cylinder into a first chamber and a second chamber, the relative size of the first chamber and the second chamber being altered as the piston moves in a first direction toward the first end or a second direction toward the second end, such that as the piston moves in the first direction, the first chamber contracts and the second chamber expands, and as the piston moves in the second direction, the first chamber expands and the second chamber contracts;
at least one unidirectional check valve in the piston that is open to permit flow through the piston as the piston moves in the first direction and is closed to block flow through the piston as the piston moves in the second direction;
at least one unidirectional check valve in the supply connection that is closed to block flow through the supply connection when the piston moves in the first direction and is open to permit flow through the supply connection into the cylinder when the piston moves in the second direction; and
at least one unidirectional check valve in the injection connection that is closed to block flow through the injection connection when the piston moves in the first direction and is open to permit flow through the injection connection when the piston moves in the second direction, the opening and closing of the check valves being activated by movement of the piston such that gel forming chemical is transferred from the first chamber to the second chamber as the piston moves in the first direction and gel forming chemical is drawn along the supply connection from the chemical tank into the first chamber and from the second chamber into the injection connection as the piston moves in the second direction.
